(19) United States
(12) Patent Application Publication
(10) Pub. No.: US 2015/0236799 A1
(43) Pub. Date: Aug. 20, 2015

(54) METHOD AND SYSTEM FOR QUICK TESTING AND DETECTING MOBILE DEVICES

(71) Applicant: Wistron Corporation, New Taipei City (TW)

(72) Inventor: Wei-Te Lee, New Taipei City (TW)

(21) Appl. No.: 14/481,902

(22) Filed: Sep. 9, 2014

(30) Foreign Application Priority Data
Feb. 20, 2014 (TW) 103105721

(51) Int. Cl. H04B 17/19; H04B 5/00

(52) U.S. Cl. CPC H04B 17/19; H04B 5/0031

(57) ABSTRACT

A method and a system for quick testing and detecting mobile devices are provided. The method includes: after starting a testing application by a first mobile device, monitoring and recording at least one action operated on a touch screen of the first mobile device to generate a first log; generating an execution script according to the at least one action by the first mobile device; packaging a name and a path of the testing application, the execution script and the first log into a message, and transferring the message to at least one second mobile device through a wireless communication network; analyzing the message and operating the testing application to generate a second log according to the execution script by the second mobile device; and comparing the first log and the second log to generate and display a comparison result.

### CROSS-REFERENCE TO RELATED APPLICATION

This application claims the priority benefit of Taiwan application serial no. 103105721, filed on Feb. 20, 2014. The entirety of the above-mentioned patent application is hereby incorporated by reference herein and made a part of this specification.

### BACKGROUND OF THE INVENTION

1. Field of the Invention

The invention relates to a method and a system for quick testing and detecting, mobile devices.

2. Description of Related Art

With rapid growth of mobile devices, in addition to improvements in operating functions of products, manufacturers also need to constantly update designs for hardware and software of the mobile devices in response to market trends, so as to satisfy the demands from the market.

Currently, for an automated testing tool of a mobile device, it is required to connect the mobile device to a computer in order to issue a command for executing a testing flow. In case a large amount of the mobile devices are to be tested at the same time, it is required to connect each of the mobile devices one-by-one to the computer in order to obtain testing results, such that a testing efficiency thereof may be lowered while a correct testing result cannot be easily obtained. Accordingly, with rapid growth of the of mobile devices and demands from the market, how to reduce complex steps for testing during developments for quickly obtaining the correct testing result has become a main target for persons skilled in the art.

### SUMMARY OF THE INVENTION

The invention is directed to a method and a system for quick testing and detecting mobile devices, capable of effectively testing and detecting software and hardware of the mobile devices.

The invention proposes a method for quick testing and detecting mobile devices for a plurality of mobile devices. The method includes: starting a testing application by a first mobile device among the mobile devices and activating a record service by the first mobile device; monitoring and recording at least one action operated on a touch screen of the first mobile device through the record service; generating an execution script according to the at least one action and storing the execution script by the first mobile device; obtaining a first log generated by the at least one action operated on the first mobile device; packaging a name and a path of the testing application, the execution script and the first log into a message by the first mobile device; and transferring the message to at least one second mobile device through a wireless communication network by the first mobile device. The method also includes: analyzing the message back to the name and the path of the testing application, the execution script and the first log, and storing the first log and the execution script by the at least one second mobile device; operating the testing application according to the name and the path of the testing application being analyzed, and executing the at least one action according to the execution script by the at least one second mobile device; obtaining a second log generated by the at least one action executed on the at least one second mobile device; and comparing the first log and the second log to generate and display a comparison result by the at least one second mobile device.

In an embodiment of the invention, the step of activating the record service includes: activating the record service by at least one hardware button of the first mobile device.

In an embodiment of the invention, the step of generating the execution script according to the at least one action and storing the execution script by the first mobile device includes: analyzing the at least one action for generating the execution script according to the at least one action and a coordinate position corresponding to the at least one action on the touch screen of the first mobile device.

In an embodiment of the invention, the step of analyzing the message back to the name and the path of the testing application, the execution script and the first log, and storing the first log and the execution script by the at least one second mobile device includes: analyzing the execution script to obtain the coordinate position corresponding to the at least one action on the touch screen of the first mobile device; and mapping the coordinate position corresponding to the at least one action onto a touch screen of the at least one second mobile device.

In an embodiment of the invention, the step of operating the testing application according to the name and the path of the testing application, and executing the at least one action according to the execution script by the at least one second mobile device includes: if an interruption occurs, re-reading the execution script stored by the at least one second mobile device and executing the at least one action according to the execution script.

In an embodiment of the invention, the method for quick testing and detecting mobile devices further includes: monitoring and recording the at least one action operated by the at least one hardware button of the first mobile device through the record service.

In an embodiment of the invention, the step of operating the testing application according to the name and the path of the testing application, and executing the at least one action according to the execution script by the at least one second mobile device includes: setting a number of execution times for executing the at least one action according to the execution script; and executing the at least one action according to the number of execution times.

In an embodiment of the invention, the message includes a first field, a second field, a third field and a fourth field, wherein the first field is configured to record the name and the path of the testing application, the second field is configured to record the execution script, the third field is configured to record the first log and the fourth field is configured to record an end identifier.

In an embodiment of the invention, the wireless communication network is Near Field Communication (NFC).

In an embodiment of the invention, a format of the message is NFC Data Exchange Format (NDEF).

In an embodiment of the invention, the at least one hardware button includes a Back button, a Home button, a Recents App button and a Volume button.

The invention proposes a system for quick testing and detecting mobile devices for a plurality of mobile devices, which includes: a first main activity module, a first record service module, a first automated execution module and a first comparison processing module disposed in a first mobile device among the mobile devices, and a second main activity module, a second record service module, a second automated execution module and a second comparison processing module disposed in a second mobile device among the mobile devices. The first main activity module is configured to start a testing application and activate a record service; and the first record service module is configured to monitor and record at least one action operated on a touch screen of the first mobile device through the record service. The first record service module is further configured to generate an execution script according to the at least one action and store the execution script. The first main activity module is further configured to obtain a first log generated by the at least one action operated on the first mobile device, and package a name and a path of the testing application, the execution script and the first log into a message by the first mobile device. Thereafter, the first main activity module is further configured to transfer the message to the second main activity module of the at least one second mobile device through a wireless communication network. In addition, the second main activity module includes an analysis processing module, wherein the analysis processing module is configured to analyze the message back to the name and the path of the testing application, the execution script and the first log, and store the first log and the execution script. The second automated execution module of the present embodiment is configured to operate the testing application according to the name and the path of the testing application, and execute the at least one action according to the execution script. The second main activity module is further configured to obtain a second log generated by the at least one action executed on the at least one second mobile device. The second comparison processing module of the present embodiment is configured to compare the first log and the second log to generate and display a comparison result.

According to an embodiment of the invention, in the operation of activating the record service in the first mobile device, the first main activity module activates the record service by at least one hardware button of the first mobile device.

In an embodiment of the invention, the first record service module is further configured to analyze the at least one action for generating the execution script according to the at least one action and a coordinate position corresponding to the at least one action on the touch screen of the first mobile device.

In an embodiment of the invention, the analysis processing module of the second main activity module is further configured to analyze the execution script to obtain the coordinate position corresponding to the at least one action on the touch screen of the first mobile device, and mapping the coordinate position corresponding to the at least one action onto a touch screen of the at least one second mobile device.

In an embodiment of the invention, the second automated execution module is further configured to, if an interruption occurs, re-read the execution script stored by the at least one second mobile device and execute the at least one action according to the execution script.

In an embodiment of the invention, the first record service module is further configured to monitor and record the at least one action operated by the at least one hardware button of the first mobile device through the record service.

In an embodiment of the invention, the second automated execution module is further configured to set a number of execution times for executing the at least one action according to the execution script, and execute the at least one action according to the number of execution times.

In an embodiment of the invention, the message includes a first field, a second field, a third field and a fourth field, wherein the first field is configured to record the name and the path of the testing application, the second field is configured to record the execution script, the third field is configured to record the first log and the fourth field is configured to record an end identifier.

In an embodiment of the invention, the wireless communication network is Near Field Communication (NFC).

In an embodiment of the invention, a format of the message is NFC Data Exchange Format (NDEF).

In an embodiment of the invention, the at least one hardware button includes a Back button, a Home button, a Recents App button and a Volume button.

Based on above, the method and the system for quick testing and detecting are capable of simultaneously testing and detecting software and hardware for multiple mobile devices by a mobile device which quickly transfers the execution script generated by the mobile device through a suitable transmission medium to the mobile devices. As a result, the complex steps in testing stage may be reduced, and a testing performance of the mobile device may be effectively

To make the above features and advantages of the disclosure more comprehensible, several embodiments accompanied with drawings are described in detail as follows.

### BRIEF DESCRIPTION OF THE DRAWINGS

FIG. 1 is a schematic diagram illustrating a first mobile device and a second mobile device according to an exemplary embodiment of the invention.

FIG. 2 is a schematic block diagram illustrating a first mobile device and a second mobile device each having a system for quick testing and detecting according to an exemplary embodiment of the invention.

FIG. 3 is a schematic block diagram illustrating an operating system platform according to an exemplary embodiment of the invention.

FIG. 4A is a schematic diagram illustrating the system for quick testing and detecting that is operated by the first mobile device according to an exemplary embodiment of the invention.

FIG. 4B is a schematic diagram illustrating the system for quick testing and detecting that is operated by the second mobile device according to an exemplary embodiment of the invention.

FIG. 5 is a schematic diagram illustrating NFC Data Exchange Format according to an exemplary embodiment of the invention.

FIG. 6 is a flowchart illustrating a method for quick testing and detecting mobile devices according to an exemplary embodiment of the invention.

### DESCRIPTION OF THE EMBODIMENTS

In order to improve a testing performance and verifying quality for mobile devices, the invention detects a plurality of mobile devices to be tested by a mobile device through a wireless communication network, so as to test multiple mobile devices simultaneously. Accordingly, the testing performance may be improved, and quality of each of the mobile devices may be ensured through a consistent test.

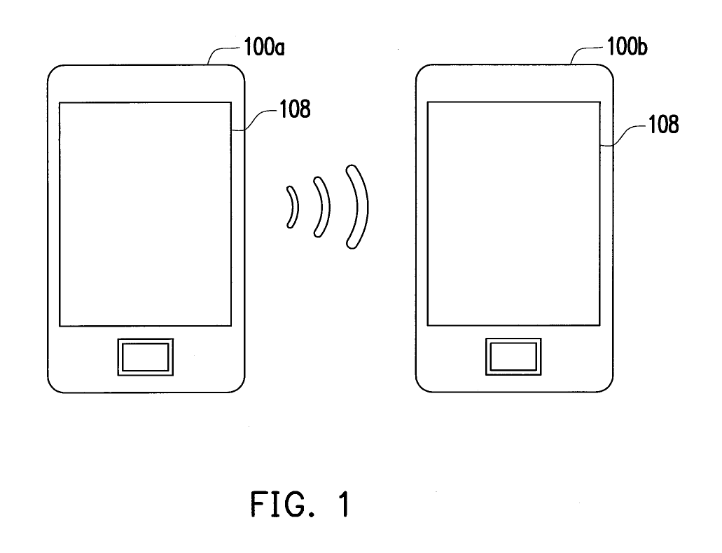

FIG. 1 is a schematic diagram illustrating a first mobile device and a second mobile device according to an exemplary embodiment of the invention.

Referring to FIG. 1, in an exemplary embodiment of the invention, a first mobile device 100a may detect a mobile device 100b to be tested through Near Field Communication (NFC), and communicate with a second mobile device being detected for transferring related information, thereby completing a test for software and hardware. Particularly, NFC is advantageous in having fast speed in pairing, thus an efficiency of the testing flow may be improved. However, the invention is not limited thereto. The invention is also suitable for other wireless communication networks.

It should be noted that, although it is illustrated with one first mobile device and one second mobile device in the present embodiment for example, but the invention is not limited thereto. For instance, the mobile device to be tested may be plural, and the first mobile device may detect those mobile devices simultaneously, so as to execute the testing flow for those mobile devices simultaneously.

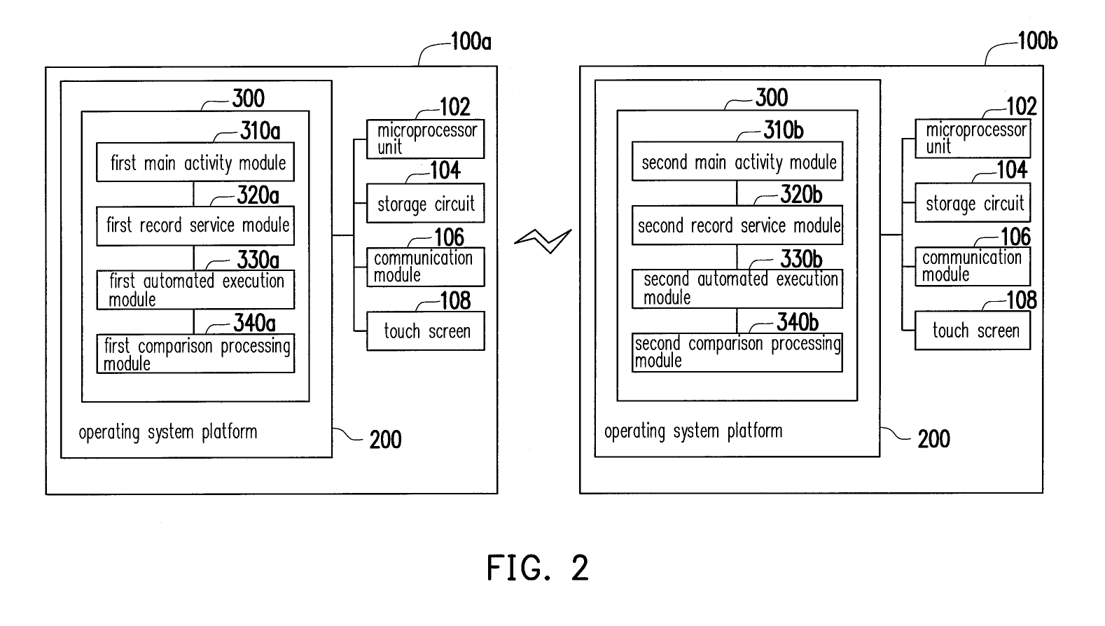

FIG. 2 is a schematic block diagram illustrating a first mobile device and a second mobile device each having a system for quick testing and detecting according to an exemplary embodiment of the invention.

Referring to FIG. 2, the first mobile device 100a and the second mobile device 100b each includes a microprocessor unit 102, a storage circuit 104, a communication module 106, a touch screen 108 and an operating system platform 200.

The microprocessor unit 102 is configured to control overall operations of a system 300 for quick testing and detecting mobile devices. For example, the microprocessor unit 102 may be a central processing unit (CPU). Particularly, the microprocessor unit 102 may issue a command to the system 300 for executing operations of testing and detecting the mobile devices.

The storage circuit 104 is coupled to the microprocessor unit 102, and configured to temporarily store commands executed by the microprocessor unit 102 or data. For instance, in the present exemplary embodiment, the storage circuit 104 may be a Dynamic Random Access Memory (DRAM), or a Static Random Access Memory (SRAM) and the like. Nevertheless, it should be understood that the invention is not limited thereto, and the storage circuit 104 may also be other appropriate memories.

The communication module 106 is coupled to the microprocessor unit 102, and configured to communicate with mobile devices other than said mobile device through the wireless communication network. For instance, the communication module 106 of the first mobile device 100a may communicate with the second mobile device 100b through the wireless communication network. In the present exemplary embodiment, the communication module 106 communicates with the other mobile devices through Near Field Communication (NFC). However, it should be understood that, the invention is not limited thereto, and the invention is also suitable for other wireless communication networks.

A touch screen 108 is coupled to the microprocessor unit 102, and configured to receive touch signals and display a plurality of objects and applications provided by the operating system platform 200.

The operating system platform 200 is a computer program configured to manage hardware and software resources for the first mobile device 100a and the second mobile device 100b. The operating system platform 200 is configured to execute basic tasks such as managing and allocating memories, deciding a priority in providing system resources, controlling I/O devices, operating networks, managing file systems and so on. In addition, the operating system platform 200 further provides an operating interface for interaction between users and said system.

In the present exemplary embodiment, the operating system platform 200 includes the system 300. More specifically, the system 300 is constructed on the operating system platform 200. The system 300 of the first mobile device 100a includes a first main activity module 310a, a first record service module 320a, a first automated execution module 330a and a first comparison processing module 340a. The system 300 of the second mobile device 100b includes a second main activity module 310b, a second record service module 320b, a second automated execution module 330b and a second comparison processing module 340b.

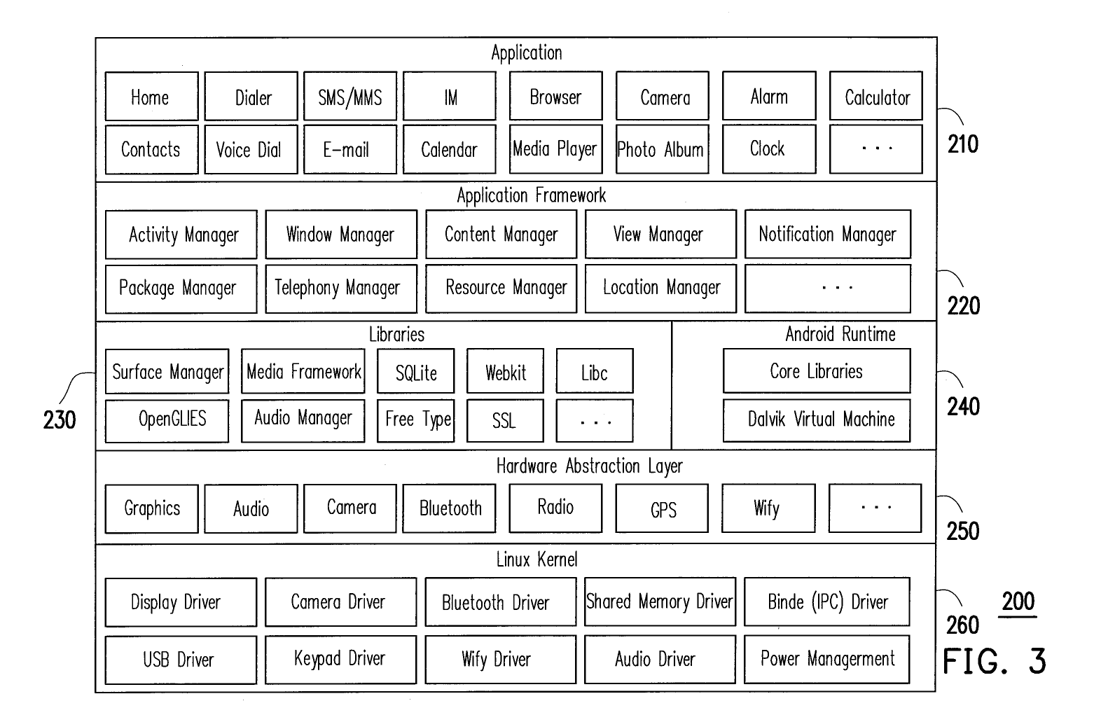

FIG. 3 is a schematic block diagram illustrating an operating system platform according to an exemplary embodiment of the invention.

Referring to FIG. 3, the operating system platform 200 for includes an Application layer 210, an Applications Frameworks layer 220, a library layer (Libraries) 230, an execution layer (Android Runtime) 240, a Hardware Abstraction layer 250 and an operating system layer (Linux Kernel) 260.

The Application layer 210 provides applications such as E-mail, SMS, calendar, instant messaging (IM), browser, camera, alarm, calculator, voice dial and contacts and so on.

The Applications Frameworks layer 220 includes managing units such as Activity Manager, Window Manager, Content Provider, View System, Notification Manager, Package Manager, Telephony Manager, Resource Manager, and Location Manager. Each of the managing units includes a specific function. For example, View System is configured to construct a basic element of one application, which includes graphic interface elements such as Lists, Grids, Text Boxes, Buttons; Notification Manager is configured to display an alerting message for each application on a place where a status bar is located; Activity Manager is configured to manage a lifetime for all applications and a general navigation back stack; Window Manager is configured to manage all window objects; and Location Manager is capable of obtaining information such as GPS location. For instance, in an exemplary embodiment, the Application layer 210 and the Applications Frameworks layer 220 are compiled by using Java language.

The library layer 230 includes a collection of libraries using C/C++, such as Surface Manager, Media Framework, SQLite, Webkit, Free Type, SSL and Libc. Functions of said libraries may be used through the Applications Frameworks layer 220. For instance, Media Framework is in compatible with many sound and video formats for playing or recording, such as MPEG4, H.264, MP3, AC, AMA, JPG and PNG; Webkit provides an advance web browser engine; Free Type provides bitmaps and vector fonts; and SSL is configured to secure web page communication protocol. The execution layer (Android Runtime) 240 includes Core Libraries and Dalvik virtual machine. More specifically, under operations of said execution layer, each application may be executed under environments of different virtual machines, and each of the virtual machines is executed by a separated Linux process. In other words, different applications are in fact executed in the separated process, respectively. Apart from a shared memory page used in special conditions between said processes, logically, locations of said processes are completely separated from one another. Therefore, private data cannot be directly accessed in between the applications for accomplishing a security purpose. The operating system layer (Linux Kernel) 260 provides Linux-based kernel system services such as security, memory management, process management, network stack, driver models and so on. In addition, the operating system layer 260 further establishes the Hardware Abstraction layer 250 for the mobile device between hardware and software, and the Hardware Abstraction layer 250 is capable of providing integrated services for hardware.

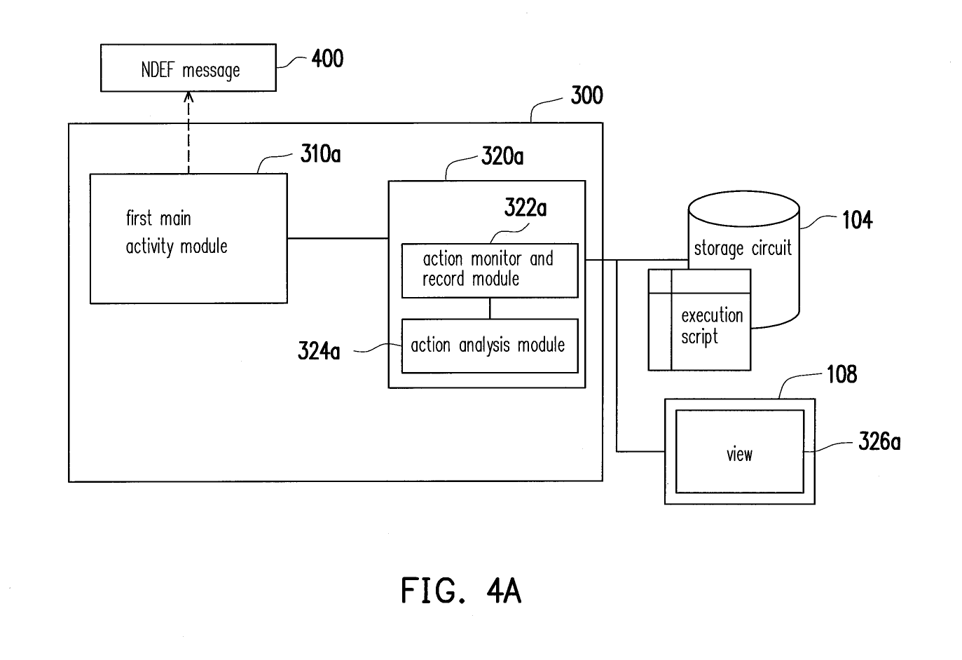

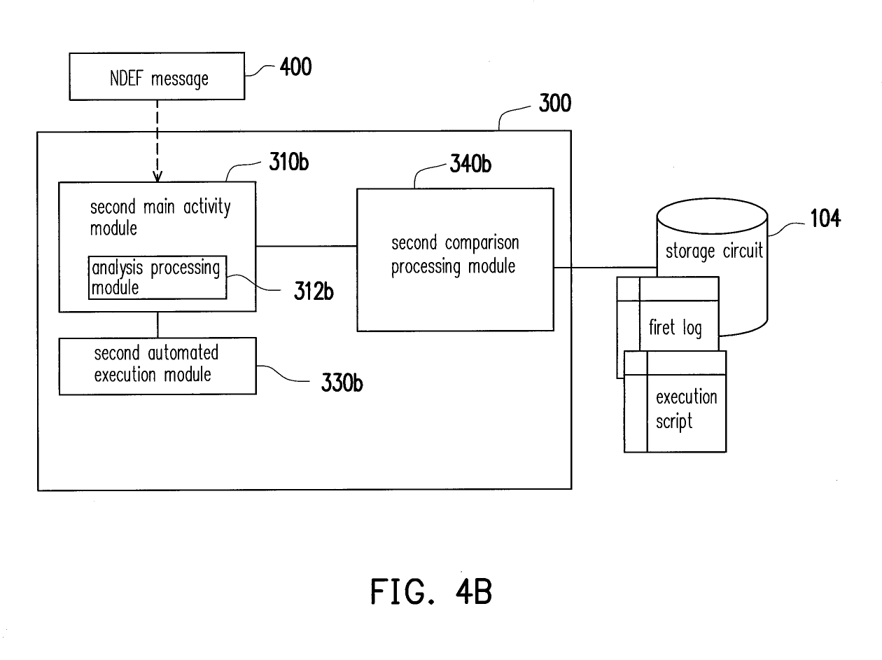

FIG. 4A is a schematic diagram illustrating the system for quick testing and detecting that is operated by the first mobile device according to an exemplary embodiment of the invention.

Referring to FIG. 4A, the first main activity module 310a starts a testing application through the first mobile device 100a and activates a record service through the first mobile device 100a thereafter. Particularly, in the operation of activating the record service in the first mobile device 100a, the first main activity module 310a activates the record service by at least one hardware button of the first mobile device 100a. The first record service module 320a is coupled to the first main activity module 310a, and includes an action monitor and record module 322a and an action analysis module 324a. The action monitor and record module 322a is configured to monitor and record at least one action operated on the touch screen 108 of the first mobile device 100a according to the record service being activated. And, the first record service module 320a generates an execution script according to the at least one action through the first mobile device 100a, and stores the execution script to the storage circuit 104 on the first mobile device 100a. More specifically, after the testing application is started by the first mobile device 100a, the first record service module 320a generates a view 326a (which is invisible) on the touch screen 108 of the first mobile device 100a, and the action monitor and record module 322a monitors and records various actions (e.g., long press, action down and action up, slide and so on) performed by a user on the view 326a on the touch screen 108. Particularly, the action analysis module 324a analyzes the at least one action, such that the first record service module 320a may generate the execution script according to the at least one action and a coordinate position corresponding to the at least one action on the touch screen 108 of the first mobile device 100a.

For instance, take events of clicking on a coordinate position (200, 400) on the touch screen 108 of the first mobile device 100a as an example, the action monitor and record module 322a first monitors an action with event being ACTION_DOWN followed by an action with event being ACTION_UP, and then the action analysis module 324a obtains the coordinate position corresponding to said actions on the touch screen 108 of the first mobile device 100a. Accordingly, the execution script generated by the first record service module 320a according to the actions and the coordinate position includes two set of data being “MotionEvent.ACTION_DOWN$200,400” and “MotionEvent.ACTION_UP$200,400”, respectively.

In an exemplary embodiment of the invention, the action monitor and record module 322a also monitors and records operations performed by the user on the first mobile device 100a to various hardware buttons of the first mobile device 100a. For example, aforesaid operations includes various events on the hardware buttons, such as pressing a Back button, a Home button and a Recents App button, or pressing a Volume button. For instance, take events of pressing the Volume button for example, the action monitor and record module 322a first monitors an action with event being “KEYCODE_VOLUME_DOWN” followed by an action with event being “KEYCODE_VOLUME_UP”. Thereafter, according to the action, the first record service module 320a generates the execution script being “KeyEvent.KEYCODE_VOLUME_DOWN$NULL,NULL” and “KeyEvent.KEYCODE_VOLUME_UP$NULL,NULL”. It should be noted that, the operations to various hardware buttons of the first mobile device 100a belong to key events which are not included with the coordinate position corresponding to the touch screen 108 of the first mobile device 100a. Therefore, the generated execution script may include a different format.

In addition, the first main activity module 310a may obtain a first log generated by the at least one action operated on the first mobile device 100a, and package a name and a path of the testing application, the execution script and the first log into a message 400 through the first mobile device 100a. Herein, a format of said message 400 is NFC Data Exchange Format (NDEF), such that the message with said format may successfully transfer data in NFC environment.

For instance, after the at least one action executed by the user is completed, the first main activity module 310a may issue a command to the operating system platform 200 of the first mobile device 100a to obtain the first log. For example, when a “logcat” command is executed, the operating system platform 200 of the first mobile device 100a returns an operating system log (i.e., the first log) to the first main activity module 310a, whereas when a “dmesg” command is executed, the operating system platform 200 of the first mobile device 100a returns a system kernel log to the first main activity module 310a.

The first main activity module 310a is further configured to transfer a NDEF message 400 through the first mobile device 100a to the second main activity module 310b of the second mobile device 100b through NFC.

FIG. 4B is a schematic diagram illustrating the system for quick testing and detecting that is operated by the second mobile device according to an exemplary embodiment of the invention.

Referring to FIG. 4B, the second main activity module 310b of the second mobile device 100b includes an analysis processing module 312b. The analysis processing module 312b is configured to analyze the message back to the name and the path of the testing application, the execution script and the first log, and store the first log and the execution script to the storage circuit 104. Particularly, the analysis processing module 312b maps the coordinate position corresponding to the at least one action onto a touch screen of the second mobile device 100b. Next, the second automated execution module 330b operates the testing application according to the name and the path of the testing application, and executes the at least one action according to the execution script analyzed by the analysis processing module 312b and the coordinate position being mapped.

In addition, the second main activity module 310b obtains a second log generated by the at least one action executed on the second mobile device 100b. For instance, after the at least one action is executed by the at least one second mobile device 100b, the second main activity module 310b may issue a command to the operating system platform 200 of the second mobile device 100b to obtain the second log. For example, when the “logcat” command is executed, the operating system platform 200 of the second mobile device 100b returns the operating system log (i.e., the second log) to the second main activity module 310b.

The second comparison processing module 340b compares the first log stored by the storage circuit 104 and the obtained second log to generate and display a comparison result. Accordingly, based on the comparison result, users or system developers may confirm whether an error occurs during operations of system software in the first mobile device 100a and the second mobile device 100b, and confirm whether the error is caused by defects in hardware when the error occurs. For example, after executing above detecting and testing mechanism to two mobile devices disposed with the same hardware, if the generated comparison result indicates “different”, such error is possibly caused by defects in system software. As another example, if the comparison result generated after executing above detecting and testing mechanism to two mobile devices disposed with the same hardware indicates “identical” while the comparison result generated after executing above detecting and testing mechanism to two mobile devices disposed with different hardware indicates “identical”, such error is possibly caused by defects in hardware.

It should be noted that, if an interrupt occurs when the second automated execution module 330b operates the testing application and executes the at least one execution script analyzed by the analysis processing module 312 through the at least one second mobile device 100b, the second automated execution module 330b may re-read the execution script stored by the storage circuit 104 on the at least one second mobile device 100b and re-execute the at least one action according to the execution script. In an exemplary embodiment of the invention, it is further provided a number of times for executing the execution script for the user to input, and the second automated execution module 330b may set a number of execution times for executing the at least one action according to the execution script, and execute the at least one action according to the number of execution times.

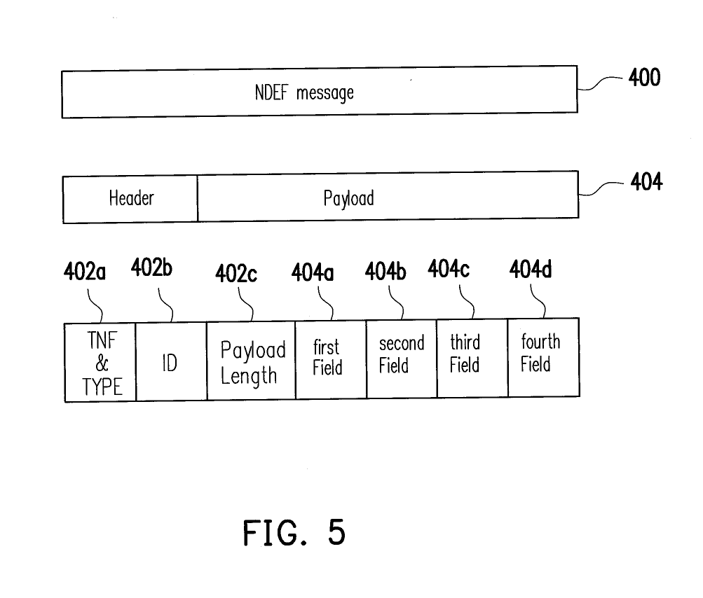

FIG. 5 is a schematic diagram illustrating NFC Data Exchange Format according to an exemplary embodiment of the invention.

Referring to FIG. 5, the NDEF message 400 may be divided in two portions including a header 402 and a payload 404, in which the header 402 includes a TNF (Type Name Format)&TYPE filed 402a, an ID field 402b and a Payload Length field 402c. The TNF&TYPE field 402a is configured to describe a type of field; and the ID field 402b is configured to serve as a unique identifier for each NDEF; and the payload length field 402c is configured to record a number of 8 bytes in the payload 404. The payload 404 of the present exemplary embodiment includes a first field 404a, a second field 404b, a third field 404c and a fourth field 404d, wherein the first field 404a is configured to record the name and the path of the testing application, the second field 404b is configured to record the execution script, the third field 404c is configured to record the first log and the fourth field 404d is configured to record an end identifier.

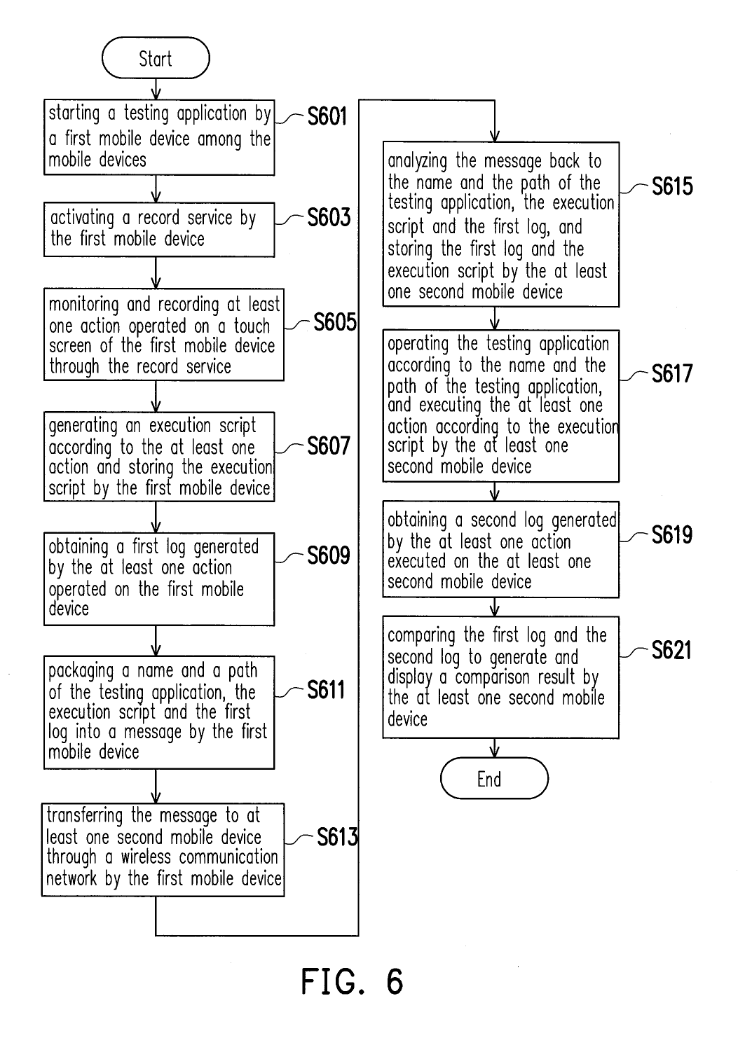

FIG. 6 is a flowchart illustrating a method for quick testing and detecting mobile devices according to an exemplary embodiment of the invention.

Referring to FIG. 6, first, the first main activity module 310a of the first mobile device 100a starts a testing application in step S601, and activates a record service in step S603.

In step S605, the action monitor and record module 322a of the first record service module 320a of the first mobile device 100a monitors and records at least one action operated on the touch screen 108 of the first mobile device 100a according to the record service. Next, in step S607, the first record service module 320a of the first mobile device 100a generates an execution script according to the at least one action and stores the execution script through the first mobile device.

In step S609, the first main activity module 310a of the first mobile device 100a obtains a first log generated by the at least one action operated on the first mobile device. And, in step S611, the first main activity module 310a of the first mobile device 100a packages a name and a path of the testing application, the execution script and the first log into a message.

Thereafter, in step S613, the first main activity module 310a transfers the message by the communication module 106 of the first mobile device 100a to the second main activity module 310b of the at least one second mobile device 100b.

In step S615, the analysis processing module 312b the second main activity module 310b of the second mobile device 100b analyzes the message back to the name and the path of the testing application, the execution script and the first log, and stores the first log and the execution script.

In step S617, the second automated execution module 330b of the second mobile device 100b is configured to operate the testing application according to the name and the path of the testing application, and execute the at least one action according to the execution script.

In step S609, the second main activity module 310b of the second mobile device 100b obtains a second log generated by the at least one action executed on the second mobile device 100b.

Lastly, in step S621, the second comparison processing module 340b of the at least one second mobile device 100b compares the first log and the second log to generate and display a comparison result through the at least one second mobile device, so as to confirm whether system software and hardware of the first mobile device 100a and the second mobile device 100b are operated normally.

In summary, the method and the system for quick testing and detecting mobile devices according to the invention are capable of directly performing communication through the mobile device to test software and hardware, and simply obtain the testing result at the mobile device without connecting the mobile device to the computer. Accordingly, the complex testing steps may be reduced to quickly and easily obtain the testing result, such that the testing performance of the mobile device may be effectively improved. In addition, because the mobile device of the invention is capable of instantly recording testing actions and generating the execution script for other mobile devices, by comparing the results generated by all the mobile devices with the same operating actions, not only is the testing efficiency improved, but quality of each mobile device may also be ensured through the consistent test.

What is claimed is:

1. A method for quick testing and detecting mobile devices for a plurality of mobile devices, and the method comprising:
starting a testing application by a first mobile device among the mobile devices;
activating a record service by the first mobile device;
monitoring and recording at least one action operated on a touch screen of the first mobile device through the record service;
generating an execution script according to the at least one action and storing the execution script by the first mobile device;
obtaining a first log generated by the at least one action operated on the first mobile device;
packaging a name and a path of the testing application, the execution script and the first log into a message by the first mobile device;
transferring the message to at least one second mobile device through a wireless communication network by the first mobile device;
analyzing the message back to the name and the path of the testing application, the execution script and the first log, and storing the first log and the execution script by the at least one second mobile device;
operating the testing application according to the name and the path of the testing application, and executing the at least one action according to the execution script by the at least one second mobile device;
obtaining a second log generated by the at least one action executed on the at least one second mobile device; and
comparing the first log and the second log to generate and display a comparison result by the at least one second mobile device.

2. The method for quick testing and detecting mobile devices of claim 1, wherein the step of activating the record service by the first mobile device comprises:
activating the record service by at least one hardware button of the first mobile device.

3. The method for quick testing and detecting mobile devices of claim 1, wherein the step of generating the execution script according to the at least one action and storing the execution script by the first mobile device comprises:
analyzing the at least one action for generating the execution script according to the at least one action and a coordinate position corresponding to the at least one action on the touch screen of the first mobile device.

4. The method for quick testing and detecting mobile devices of claim 3, wherein the step of analyzing the message back to the name and the path of the testing application, the execution script and the first log, and storing the first log and the execution script by the at least one second mobile device comprises:
analyzing the execution script to obtain the coordinate position corresponding to the at least one action on the touch screen of the first mobile device; and
mapping the coordinate position corresponding to the at least one action onto at least one touch screen of the at least one second mobile device.

5. The method for quick testing and detecting mobile devices of claim 4, wherein the step of operating the testing application according to the name and the path of the testing application, and executing the at least one action according to the execution script by the at least one second mobile device comprises:
if an interruption occurs, re-reading the execution script stored by the at least one second mobile device and executing the at least one action according to the execution script.

6. The method for quick testing and detecting mobile devices of claim 1, further comprising:
monitoring and recording the at least one action operated by the at least one hardware button of the first mobile device through the record service;

7. The method for quick testing and detecting mobile devices of claim 1, wherein the step of operating the testing application according to the name and the path of the testing application, and executing the at least one action according to the execution script by the at least one second mobile device comprises:
setting a number of execution times for executing the at least one action according to the execution script; and
executing the at least one action according to the number of execution times.

8. The method for quick testing and detecting mobile devices of claim 7, wherein the message comprises a first field, a second field, a third field and a fourth field, wherein the first field is configured to record the name and the path of the testing application, the second field is configured to record the execution script, the third field is configured to record the first log and the fourth field is configured to record an end identifier.

9. The method for quick testing and detecting mobile devices of claim 1, wherein the wireless communication network is Near Field Communication (NFC).

10. The method for quick testing and detecting mobile devices of claim 9, wherein a format of the message is NFC Data Exchange Format (NDEF).

11. The method for quick testing and detecting mobile devices of claim 2, wherein the at least one hardware button comprises a Back button, a Home button, a Recents App button and a Volume button.

12. A system for quick testing and detecting mobile devices for a plurality of mobile devices, and the system comprising:
a first main activity module, a first record service module, a first automated execution module and a first comparison processing module, wherein the first main activity module, the first record service module, the first automated execution module and the first comparison processing module are disposed on a first mobile device among the mobile devices; and
a second main activity module, a second record service module, a second automated execution module and a second comparison processing module, wherein the second main activity module, the second record service module, the second automated execution module and the second comparison processing module are disposed on a second mobile device among the mobile devices,
wherein the first main activity module is configured to start a testing application in the first mobile device and activate a record service in the first mobile device,
wherein the first record service module is configured to monitor and record at least one action operated on a touch screen of the first mobile device through the record service,
wherein the first record service module is further configured to generate an execution script according to the at least one action and store the execution script,
wherein the first main activity module is further configured to obtain a first log generated by the at least one action operated on the first mobile device,
wherein the first main activity module is further configured to package a name and a path of the testing application, the execution script and the first log into a message,
wherein the first main activity module is further configured to transfer the message to the second main activity module of the second mobile device through a wireless communication network,
wherein the second main activity module of the second mobile device comprises an analysis processing module, and the analysis processing module is configured to analyze the message back to the name and the path of the testing application, the execution script and the first log, and store the first log and the execution script,
wherein the second automated execution module is configured to operate the testing application according to the name and the path of the testing application, and execute the at least one action according to the execution script,
wherein the second main activity module is further configured to obtain a second log generated by the at least one action executed on the second mobile device,
wherein the second comparison processing module is configured to compare the first log and the second log to generate and display a comparison result.

13. The system for quick testing and detecting mobile devices of claim 12, wherein in the operation of activating the record service in the first mobile device, the first main activity module is further configured to activate the record service by at least one hardware button of the first mobile device.

14. The system for quick testing and detecting mobile devices of claim 12, wherein the first record service module is further configured to analyze the at least one action for generating the execution script according to the at least one action and a coordinate position corresponding to the at least one action on the touch screen of the first mobile device.

15. The system for quick testing and detecting mobile devices of claim 14, wherein the analysis processing module of the second main activity module is further configured to analyze the execution script to obtain the coordinate position corresponding to the at least one action on the touch screen of the first mobile device,
wherein the analysis processing module is further configured to map the coordinate position corresponding to the at least one action onto a touch screen of the second mobile device.

16. The system for quick testing and detecting mobile devices of claim 15, wherein the second automated execution module is further configured to, if an interruption occurs, re-read the execution script stored by the second mobile device and execute the at least one action according to the execution script.

17. The system for quick testing and detecting mobile devices of claim 16, wherein the first record service module is further configured to monitor and record the at least one action operated by the at least one hardware button of the first mobile device through the record service.

18. The system for quick testing and detecting mobile devices of claim 12, wherein the second automated execution module is further configured to set a number of execution times for executing the at least one action according to the execution script,
wherein second automated execution module is further configured to execute the at least one action according to the number of execution times.

19. The system for quick testing and detecting mobile devices of claim 18, wherein the message comprises a first field, a second field, a third field and a fourth field, wherein the first field is configured to record the name and the path of the testing application, the second field is configured to record the execution script, the third field is configured to record the first log and the fourth field is configured to record an end identifier.

20. The system for quick testing and detecting mobile devices of claim 12, wherein the wireless communication network is Near Field Communication (NFC).

21. The system for quick testing and detecting mobile devices of claim 20, wherein a format of the message is NFC Data Exchange Format (NDEF).

22. The system for quick testing and detecting mobile devices of claim 13, wherein the at least one hardware button comprises a Back button, a Home button, a Recents App button and a Volume button.
